(19) United States
(12) Patent Application Publication
(10) Pub. No.: US 2025/0128226 A1
(43) Pub. Date: Apr. 24, 2025

(54) CONTINUOUS REACTION SYSTEMS AND METHODS

(71) Applicant: Georgia Tech Research Corporation, Atlanta, GA (US)

(72) Inventors: Hossein Salami, Atlanta, GA (US); Andreas Sebastian Bommarius, Atlanta, GA (US); Martha Anne Grover, Atlanta, GA (US); Ronald William Rousseau, Atlanta, GA (US)

(21) Appl. No.: 18/681,546

(22) PCT Filed: Aug. 31, 2022
(86) PCT No.: PCT/US2022/075753

§ 371 Date: Feb. 6, 2024

Related U.S. Application Data
(60) Provisional application No. 63/238,828, filed on Aug. 31, 2021.

(51) Int. Cl. B01J 8/12; B01D 21/00; B01J 8/00; B01J 8/02; B01J 19/18

(52) U.S. Cl. CPC B01J 8/12; B01D 21/00; B01J 8/001; B01J 8/0095; B01J 8/02; B01J 19/18; B01J 2219/2475

(57) ABSTRACT

Disclosed herein are continuous reaction systems comprising a reaction vessel defining an interior volume and containing a plurality of inert scaffold particles. The reaction vessel can comprise an inlet line to provide one or more reactants to the interior volume such that the one or more reactants contact the plurality of inert scaffold particles. The reaction vessel can further comprise an outlet line to remove one or more products from the interior volume that result from a contact between the one or more reactants and the plurality of inert scaffold particles. The reaction vessel can also include a sieve material disposed on the outlet line within the interior volume configured to reject the plurality of inert scaffold particles and allow the one or more products to pass into the outlet line.

### CROSS-REFERENCE TO RELATED APPLICATIONS

This application claims the benefit of U.S. Provisional Application Ser. No. 63/238,828, filed on 31 Aug. 2021, the entire contents and substance of which are incorporated herein by reference in their entirety as if fully set forth below.

### STATEMENT OF RIGHTS UNDER FEDERALLY SPONSORED RESEARCH

This invention was made with government support under Award No. U01FD006484 by the U.S. Food and Drug Administration. The government has certain rights in the invention.

### FIELD OF THE DISCLOSURE

The present disclosure relates generally to continuous reaction systems and methods. Particularly, embodiments of the present disclosure relate to isokinetic withdrawal of solid products from a continuous reaction vessel.

### BACKGROUND

The chemical industry can benefit from the advantages of continuous processes, such as higher productivity, the ability to process higher concentration of reactants, relatively smaller reactor size, potentially smaller environmental footprint, and higher flexibility in operation and control. The pharmaceutical industry, on the other hand, lags in capitalizing on this technology and is mainly dominated by batch systems. One reason is the existence of an already well-developed knowledge and equipment base, which is reinforced by tight regulations and intense time pressure to introduce a new drug to the market. However, there has been a push to move towards using continuous processes in this industry. This shift is motivated by the listed advantages and is encouraged by pharmaceutical companies as well as regulatory agencies such as the United States Food and Drug Administration (FDA). Changing from batch to continuous processes can also provide an opportunity for implementation of Quality by Design and for introducing new process observation and control technologies in the newly designed processes.

Crystallization is one of the processes in the pharmaceutical industry, where it can be used for purification of small-molecule drugs and the preparation of marketed drug forms with specific attributes, such as dissolution rate. Considering that many small-molecule drugs can be administered in crystal form, development of robust, continuous crystallization processes can be useful for exploiting the aforementioned benefits.

In some cases, combining the crystallization with the synthesis step into a Reactive Crystallization (RC) process may be useful. In general, there can be two motivating factors to combine these two steps. The first is the potential for process intensification. If possible, combining both reaction and crystallization steps into one unit operation may save capital and operating costs. Examples can include cases where the synthesis reaction has fast kinetics under a wide range of conditions so that process variables can be set to optimize the crystallization kinetics. Fast reactions are common in the production of inorganic compounds, such as Li₂CO₃, or coupling and neutralization reactions for organic compounds.

Many RC processes deal with such systems; examples include continuous reactive crystallization of ferrihydrite and sodium cefuroxime. In many processes, however, conditions favorable to both reaction and crystallization might not exist. For example, the variable of temperature can have a strong handle on the kinetics of both steps, but usually with opposite effects. Either different process times, or different parts of a single vessel, or multiple integrated vessels can be used to perform reaction and crystallization steps. Conditions at different stages can be set to favor the corresponding step. While usually referred to as RC, we note that as disclosed herein the reaction and the crystallization steps need not occur simultaneously but can rather occur as separated steps integrated into an overall process.

The second motivating factor for combining reaction and crystallization can be when one can improve the efficiency of the other. Examples include improving the enantiomeric excess, shifting the reaction equilibrium by simultaneous crystallization of the desired product, or controlling the rate of supersaturation generation. Examples of such processes, such as in situ crystallization of the antibiotic in enzymatic synthesis of beta-lactam antibiotics, can lead to improvement in process yield and conversion. In the synthesis of amoxicillin (AMX) using the biocatalyst Pen G Acylase (PGA), the in-situ crystallization can help protect the desired product from hydrolysis. A similar concept can be applied to produce other beta-lactam antibiotics such as cephalexin (CEX).

What is needed, therefore, are continuous reaction systems and methods that can allow for the continuous withdrawal and production of one or more solid products from a reactions vessel without withdrawal of a solid catalyst. Embodiments of the present disclosure address this need as well as other needs that will become apparent upon reading the description below in conjunction with the drawings.

### BRIEF SUMMARY OF THE DISCLOSURE

The present disclosure relates generally to continuous reaction systems and methods. Particularly, embodiments of the present disclosure relate to isokinetic withdrawal of solid products from a continuous reaction vessel.

An exemplary embodiment of the present disclosure can provide a continuous reaction system comprising: a reaction vessel defining an interior volume and containing a plurality of inert scaffold particles, the reaction vessel comprising: an inlet line to provide one or more reactants to the interior volume such that the one or more reactants contact the plurality of inert scaffold particles; an outlet line to remove one or more products from the interior volume that result from a contact between the one or more reactants and the plurality of inert scaffold particles, the one or more products being in a solid state; and a sieve material disposed on the outlet line within the interior volume, the sieve material configured to reject the plurality of inert scaffold particles and allow the one or more products to pass therethrough into the outlet line.

In any of the embodiments disclosed herein, the sieve material can have a pore size, and the size of each of the plurality of inert scaffold particles is greater than the pore size.

In any of the embodiments disclosed herein, the sieve material can achieve isokinetic withdrawal of the one or more products in the solid state.

In any of the embodiments disclosed herein, each of the plurality of inert scaffold particles can contain an active catalyst.

In any of the embodiments disclosed herein, the contact between the one or more reactants and the plurality of inert scaffold particles can cause a reaction facilitated by the active catalyst.

In any of the embodiments disclosed herein, the reaction can occur within the interior volume and the one or more products can be formed prior to contact with the sieve material.

In any of the embodiments disclosed herein, the reaction can be a crystallization reaction to create the one or more products in the solid state, wherein the solid state is a crystalline state.

In any of the embodiments disclosed herein, the system can further comprise a comminution unit having an inlet line connected to the reaction vessel and a recycle line connected with the interior volume of the reaction vessel, the comminution unit being configured to reduce a particle size of the one or more products in the solid state subsequent to the one or more products passing through the sieve material.

In any of the embodiments disclosed herein, the system can further comprise a separation unit having an inlet line connected with the outlet line of the reaction vessel, a retentate line connected with the inlet line of the comminution unit, and a permeate line, the separation unit configured to allow the one or more products having a size below a predetermined threshold pass through into the permeate line and reject the one or more products having a size above the predetermined threshold flow from the retentate line to the comminution unit.

In any of the embodiments disclosed herein, the comminution unit can be a mill.

In any of the embodiments disclosed herein, the comminution unit can be configured to reduce the particle size of the one or more products to achieve a predetermined particle size distribution.

In any of the embodiments disclosed herein, the particle size distribution can be selected to achieve isokinetic withdrawal of the one or more products in the solid state from the reaction vessel.

Another embodiment of the present disclosure can provide a continuous reaction method comprising: feeding, to an interior volume of a reaction vessel, one or more reactants through an inlet line to the interior volume; contacting the one or more reactants with a plurality of inert scaffold particles within the interior volume to form one or more products, the plurality of inert scaffold particles and the one or more products being in a solid state; sieving the one or more products through a sieve material disposed on an outlet line exiting the interior volume, the sieve material configured to reject the plurality of inert scaffold particles and allow the one or more products to pass therethrough into the outlet line.

In any of the embodiments disclosed herein, the sieve material can have a pore size, and the size of each of the plurality of inert scaffold particles can be greater than the pore size.

In any of the embodiments disclosed herein, sieving the one or more products through the sieve material can be performed to achieve isokinetic withdrawal of the one or more products in the solid state.

In any of the embodiments disclosed herein, each of the plurality of inert scaffold particles can contain an active catalyst.

In any of the embodiments disclosed herein, wherein contacting the one or more reactants with the plurality of inert scaffold particles can comprise a reaction facilitated by the active catalyst.

In any of the embodiments disclosed herein, the reaction can occur within the interior volume and the one or more products can be formed prior to contact with the sieve material.

In any of the embodiments disclosed herein, the reaction can be a crystallization reaction to create the one or more products in the solid state, wherein the solid state is a crystalline state.

In any of the embodiments disclosed herein, the method can further comprise: feeding the one or more products to a comminution unit having an inlet line connected to the reaction vessel and a recycle line connected with the interior volume of the reaction vessel; and reducing, by the comminution unit, a particle size of the one or more products in the solid state subsequent to the one or more products passing through the sieve material.

In any of the embodiments disclosed herein, the method can further comprise: transferring, prior to feeding the one or more products to the comminution unit, the one or more products to a separation unit having an inlet line connected with the outlet line of the reaction vessel, a retentate line connected with the inlet line of the comminution unit, and a permeate line; permeating, by the separation unit, the one or more products having a size below a predetermined threshold into the permeate line; and rejecting the one or more products having a size above the predetermined threshold into the retentate line and subsequently to the comminution unit.

In any of the embodiments disclosed herein, the comminution unit can be a mill.

In any of the embodiments disclosed herein, the comminution unit can be configured to reduce the particle size of the one or more products to achieve a predetermined particle size distribution.

In any of the embodiments disclosed herein, the particle size distribution can be selected to achieve isokinetic withdrawal of the one or more products in the solid state from the reaction vessel.

These and other aspects of the present disclosure are described in the Detailed Description below and the accompanying figures. Other aspects and features of embodiments of the present disclosure will become apparent to those of ordinary skill in the art upon reviewing the following description of specific, exemplary embodiments of the present invention in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 illustrates an example continuous reaction system in accordance with the present disclosure.

FIG. 2 illustrates a flowchart of a continuous reaction method in accordance with the present disclosure.

FIG. 3 illustrates an example reaction scheme of a continuous reaction method in accordance with the present disclosure.

FIG. 4A illustrates a system diagram of an example continuous reaction system in accordance with the present disclosure.

FIG. 4B illustrates optical microscopy images of one or more products made in an example continuous reaction system in accordance with the present disclosure.

FIGS. 5A and 5B illustrate plots of activity depending on carrier size and nucleophile concentration for examples of continuous reaction methods in accordance with the present disclosure.

FIGS. 6A and 6B illustrate plots of selectivity depending on carrier size and nucleophile concentration for examples of continuous reaction methods in accordance with the present disclosure.

FIG. 7 illustrate plots of conditions in a continuous reaction system in accordance with the present disclosure.

FIGS. 8A-C illustrate plots of solids densities at different withdrawal rates for examples of continuous reaction methods in accordance with the present disclosure.

FIGS. 9A-D illustrate plots of size distributions for examples of continuous reaction methods in accordance with the present disclosure.

FIG. 10 illustrates a plot of number and mass based means for particle size produced by examples of continuous reaction methods in accordance with the present disclosure.

FIGS. 11A-C illustrate plots of solids densities at different withdrawal rates for examples of continuous reaction methods in accordance with the present disclosure.

FIGS. 12A-D illustrate plots of size distributions for examples of continuous reaction methods in accordance with the present disclosure.

FIG. 13 illustrates a plot of solids density for an example of continuous reaction methods in accordance with the present disclosure.

FIG. 14 illustrates a plot of the effects of various conditions on filtration rate of continuous reaction methods in accordance with the present disclosure.

### DETAILED DESCRIPTION

Combining the synthesis and crystallization of a compound into a single step can be beneficial for certain processes. Motivations can range from process intensification to improving reaction network yield by shifting an equilibrium or protecting an intermediate. Adapting such a reactive crystallization process to continuous manufacturing faces a challenge: the continuous separation of crystal products from solid catalyst carriers.

Disclosed herein are size-based methods for this separation problem. Separation can be performed using a filter placed on the reactive crystallization vessel outlet. The primary factors for filter design are carrier and crystal size dictated by the separation condition L_{crystal}<L_{filter}<L_{carrier}. To avoid a loss of activity and selectivity for a catalyst when large carrier sizes are used for immobilization, the maximum L_{carrier} can be limited as desired.

Furthermore, intermittent wet milling can be effective in reducing the crystal size and allowing the use of relatively smaller carriers while still satisfying the criterion for solid-solid separation. Slurry transfer tests can be performed to check the possibility of isokinetic withdrawal when the separator filter is used. By way of illustration, a filter size of 300 μm, a carrier size of 300 to 425 μm, and intermittent milling at 5000 RPM with the frequency of 2 to 3 reactor volumes per residence time can be used to provide an almost complete separation, acceptable catalyst kinetics, and an isokinetic crystal withdrawal.

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

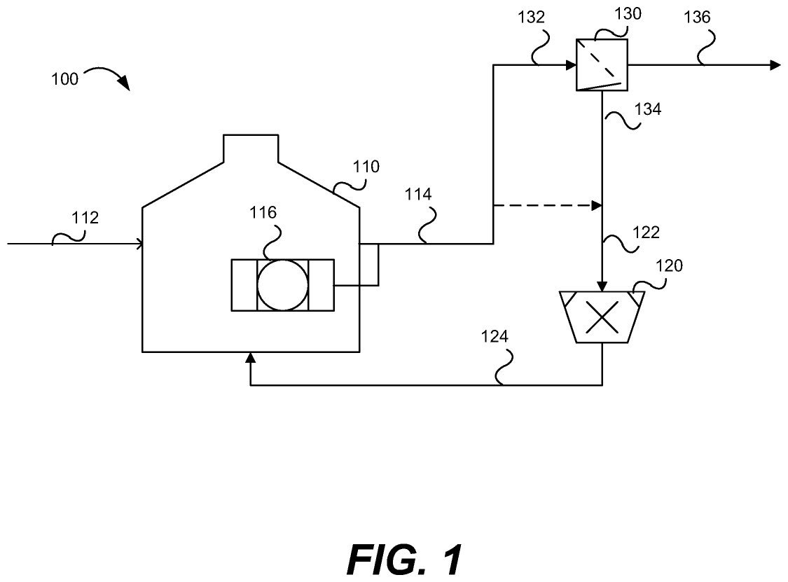

FIG. 1 illustrates a continuous reaction system 100. As shown, the continuous reaction system 100 can comprise a reaction vessel 110. The reaction vessel 110 can define an interior volume. The reaction vessel 110 can be any suitable vessel to define an interior volume. For example, the reaction vessel 110 can be a continuous stirred tank reactor (CSTR), a multistage continuous mixed-suspension mixed-product removal reactor (MSMPR), a plug flow reactor (PFR), and the like. It is understood that the reaction vessel 110 can also be any suitable tank that can contain an interior volume and/or one or more materials within an interior volume. The reaction vessel 110 can be any suitable geometry, orientation, or material as desired to accommodate the interior volume.

The reaction vessel 110 can contain a variety of materials within the interior volume. For instance, the interior volume can contain a plurality of inert scaffold particles. The inert scaffold particles can serve a variety of purposes. For instance, the inert scaffold particles can contain a catalyst. The inert scaffold particles can also have other purposes, such as aeration, temperature control, and the like. The inert scaffold particles can be selected to be non-reactive when placed within the interior volume and contacted with one or more reactants. Other materials can be present in the interior volume, such as coatings for the reaction vessel 110, emulsifiers, surfactants, and the like.

The reaction vessel 110 can comprise an inlet line 112 and an outlet line 114. The inlet line 112 and the outlet line 114 can be any suitable piping or plumbing as necessary to maintain a continuous flow into and out of the reaction vessel 110. The inlet line 112 and the outlet line 114 can lead from external to the reaction vessel 110 to the interior volume of the reaction vessel 110. The inlet line 112 can provide material to the interior volume of the reaction vessel 110, and the outlet line can remove material from the interior volume of the reaction vessel 110. For instance, the inlet line 112 can provide one or more reactants to the interior volume, where one or more reactants contact the plurality of inert scaffold particles. The outlet line can then remove one or more products from the interior volume that form from the contact between the one or more reactants and the plurality of inert scaffold particles. The one or more products that form can be in solid form, such as from the result of a crystallization.

As described above, the plurality of inert scaffold particles contain an active catalyst. In such a case, the contact of the one or more reactants with the active catalyst can facilitate a reaction. Furthermore, the reaction can be a multi-step process. For instance, the catalyst can facilitate a reaction in a first step to form one or more products, and a solvent present in the reaction vessel 110 can cause the one or more products to crystallize in a second step. In such a manner, the reaction vessel 110 can provide for a reaction-crystallization process.

The reaction vessel 110 can further comprise a sieve material 116 disposed on the outlet line 114 within the interior volume. The sieve material 116 can be positioned at an entrance to the outlet line 114 from the interior volume. The sieve material 116 can be configured in such a manner to reject the plurality of inert scaffold particles and allow the one or more products to pass therethrough into the outlet line 114. In other words, the sieve material 116 can allow the one or more products, and not the inert scaffold particles, to exit the interior volume through the outlet line 114. For example, the sieve material 116 can have a pore size where the inert scaffold particles have a size greater than the pore size such that the inert scaffold particles cannot pass through. In such an example, the one or more products can be maintained at a size distribution that allows the one or more products to pass through the sieve material 116. The sieve material 116 can further be configured in such a manner to achieve isokinetic withdrawal of the one or more products from the interior volume.

As shown, the continuous reaction system 100 can further comprise a comminution unit 120. The comminution unit 120 can have an inlet line 122 that connects to the outlet line 114 of the reaction vessel 110 and feeds into the comminution unit 120. The comminution unit 120 can further have a recycle line 124 that exits the comminution unit 120 and feeds into the interior volume of the reaction vessel 110. In such a manner, the comminution unit 120 can receive material exiting the reaction vessel 110 and feed material back into the reaction vessel 110 after processing.

The comminution unit 120 can be configured to reduce, maintain, and/or manage a particle size distribution of material exiting the reaction vessel 110, such as the one or more solid products. After size reduction, the one or more solid products can be recycled back into the reaction vessel 110. In such a manner, particle size distribution within the interior volume of the reaction vessel 110 can be maintained such that the one or more products can continue to pass through the sieve material 116. As would be appreciated, reduced particle sizes can reduce fouling and clogging while increasing removal and recovery from within the reaction vessel 110.

The comminution unit 120 can be configured to maintain a particle size distribution, or the comminution unit 120 can be configured to reduce particles to a set size. For example, the comminution unit 120 can have a predetermined particle size threshold to which it can reduce the particles entering the comminution unit 120. Alternatively, or in addition, the comminution unit 120 can have a predetermined particle size distribution at which it maintains the particles being recycled back to the reaction vessel 110. In such a manner, the particle size distribution can be selected and maintained such that the one or more products can be withdrawn isokinetically from the reaction vessel 110.

The comminution unit 120 can be selected as desired. For example, the comminution unit can include one of, or any combination of, any mill, any crusher, a wet mill, a hammer mill, a ball mill, a vertical roller mill, a roller press, a vibration mill, a jet mill, a jaw crusher, a cone crusher, a hammer crusher, a pulverizer, and the like.

As shown, the continuous reaction system 100 can further comprise a separation unit 130. The separation unit 130 can have an inlet line 132 connected with the outlet line 114 of the reaction vessel 110. The separation unit 130 can further have a retentate line 134 connected with the inlet line 122 of the comminution unit 120. The separation unit 130 can also have a permeate line 136 configured to transport material that permeates through the separation unit 130. The separation unit 130 can work in conjunction with the comminution unit 120.

The separation unit 130 can be configured such that material having a size below a predetermined threshold can pass through into the permeate line 136 and material having a size above the predetermined threshold can be rejected into the retentate line 134 where it can be fed into the comminution unit 120 to reduce the size thereof. In such a manner, the separation unit 130 can work in conjunction with the comminution unit 120 to reduce the particle size of the one or more products and/or maintain a particle size distribution in the reaction vessel 110.

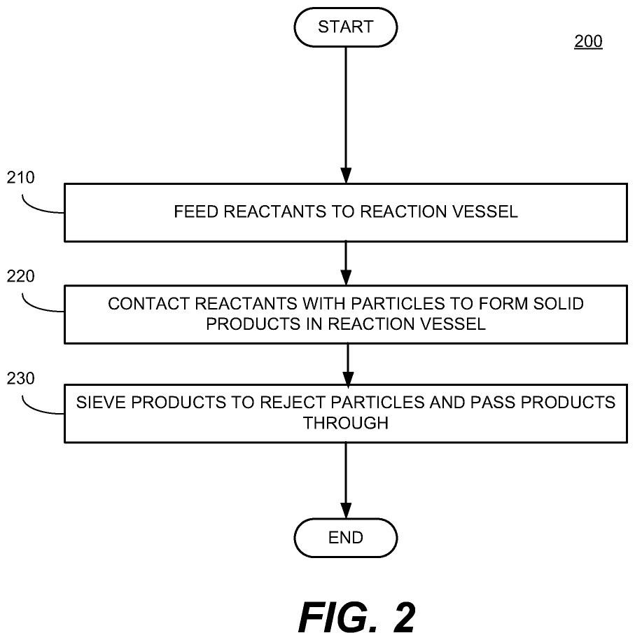

FIG. 2 is a flowchart of a continuous reaction method 200. As shown in block 210, the method 200 can comprise feeding one or more reactants through an inlet line 112 to the interior volume of the reaction vessel 110. The method 200 can then proceed on to block 220.

In block 220, the method 200 can comprise contacting the one or more reactants with a plurality of inert scaffold particles within the interior volume to form one or more products. The reaction can include a reaction-crystallization step such that the one or more products form in the crystalline (or solid) state. The reaction can be facilitated by a catalyst attached to the inert scaffold particles. The method 200 can then proceed on to block 230.

In block 230, the method 200 can comprise sieving the one or more products through the sieve material 116 disposed on the outlet line 114 exiting the interior volume prior to exiting the reaction vessel 110. The sieve material 116 can be configured to reject the inert scaffold particles and allow the one or more products to pass through, as described above. In some examples, the method 200 can terminate after block 230. However, in some examples the method 200 can proceed on to other method steps not shown.

Other method steps can be present in the method 200 not explicitly shown in FIG. 2 but described above. For example, the method 200 can include feeding the one or more products to the comminution unit 120 to maintain a particle size distribution within the reaction vessel 110. This step can include feeding the one or more products to the comminution unit 120 through the inlet line 122 connected to the outlet line 114 of the reaction vessel 110, reducing the particle size of the one or more products subsequent to the products passing through the sieve material 116, and recycling the one or more products through the recycle line 124 connected with the interior volume of the reaction vessel 110.

Another method step in the method 200 can include transferring the one or more products to the separation unit 130 through the inlet line 132 connected with the outlet line 114 of the reaction vessel 110. This can occur prior to feeding the one or more products to the comminution unit 120. This step can also include permeating the one or more products having a size below a predetermined threshold into the permeate line 136 and rejecting one or more products having a size above the predetermined threshold into the retentate line 134 to be fed to the comminution unit 120.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

### EXAMPLES

The following examples are provided by way of illustration but not by way of limitation.

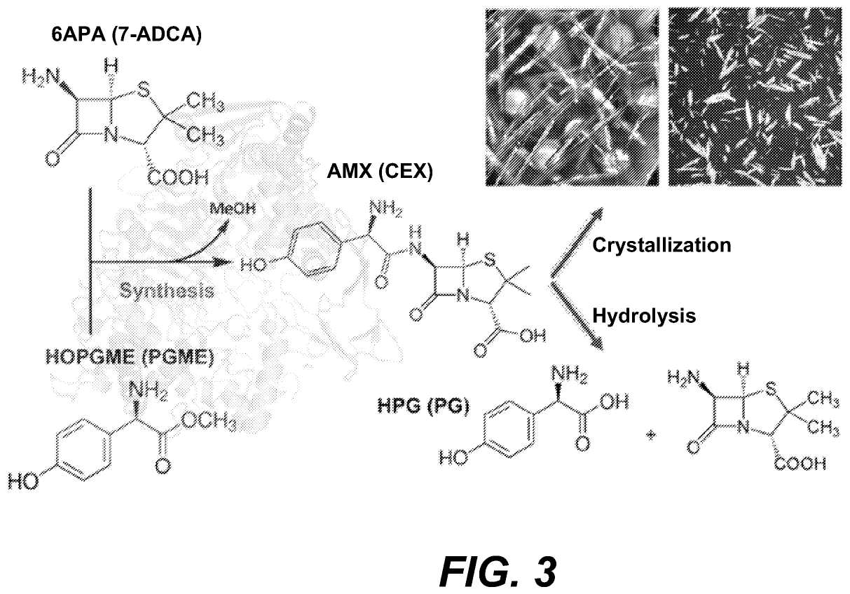

As mentioned, developing continuous RC processes for cases with fast reaction kinetics (e.g., ionic reactions, neutralization, etc.) can be driven by crystallization demanding most of the attention. However, in many cases, particularly in the pharmaceutical industry, this task can be complicated by challenges in the synthesis step. Synthesis of some products can utilize a complex cascade of reactions that might not be compressible into one continuous vessel, or the reaction might need a catalyst to proceed with an acceptable rate (e.g., enzymatic synthesis of beta-lactam antibiotics shown in FIG. 3). There can be two particular possibilities, out of many, for a continuous enzymatic process. The soluble enzyme can be continuously supplied to the system together with the reaction species to maintain a certain concentration; however, considering the biocatalyst value, this case is not expected to be economical. A more viable solution can be to retain the biocatalyst in the process. Most methods to do this can require immobilizing the biocatalyst on some type of organic or inorganic carrier. The use of packed bed reactors is common, where the enzyme can be immobilized on beads that are then packed to form the biocatalyst bed. Alternative approaches can include ultrafiltration membranes, hollow fiber membranes, or bi-phasic separation systems. Unfortunately, most of these setups struggle when used in RC processes where the presence of a second solid type (i.e., crystals) complicates the process. A major challenge in adapting enzymatic reactive crystallization processes, such as that of FIG. 3, to continuous manufacturing is establishing a separation strategy that allows for continuous, selective, and isokinetic removal of product crystals (i.e., when solids density and size distribution of the withdrawn sample closely match those of the crystallizer) from the RC vessel while maintaining (or recycling) the biocatalyst.

As disclosed herein, solutions for the above separation problem can range from size-based methods to those that use an external force field such as gravity. Separation based on gravity can be feasible if the two solids have significantly different densities and settling velocities. Microfluidics-based solid-solid separation devices can be introduced for several applications, but the extreme tendency to clog and low throughput can limit their application for large-scale processes.

Size-based methods for separation can appear simple in working principle but require a difference between the size of crystals and the size of the biocatalyst carrier. It can be desirable to achieve a near-perfect retention of the biocatalyst in the vessel, but not a full recovery of all crystals. For example, some may be retained in the vessel for further growth. There can be two possibilities, out of many, to separate the two solid types based on their size: (1) choose a carrier size smaller than the crystal size (L_{carrier}<L_{crystal}), and (2) choose a relatively large carrier such that L_{crystal}<L_{carrier}. In the first option, a sieve with appropriate size can be used to separate the large crystals and recycle the beads to the RC vessel. The main issue with this approach is that it is almost certain that a significant number of beads will be trapped in the crystal cake during sieving, which not only leads to loss of biocatalyst but also significantly contaminates the crystal product. In the second approach, large beads can be maintained on top of the sieve and can be scrubbed off and recycled back to the RC vessel (along with some entrapped crystals). If the right combination of L_{carrier} and L_{filter} is used, this method can provide a high biocatalyst recovery. However, performing the separation step downstream of the RC vessel can add a non-continuous element to the otherwise continuous process. Furthermore, biocatalyst carriers might be severely damaged while being scrubbed off the sieve to be recycled.

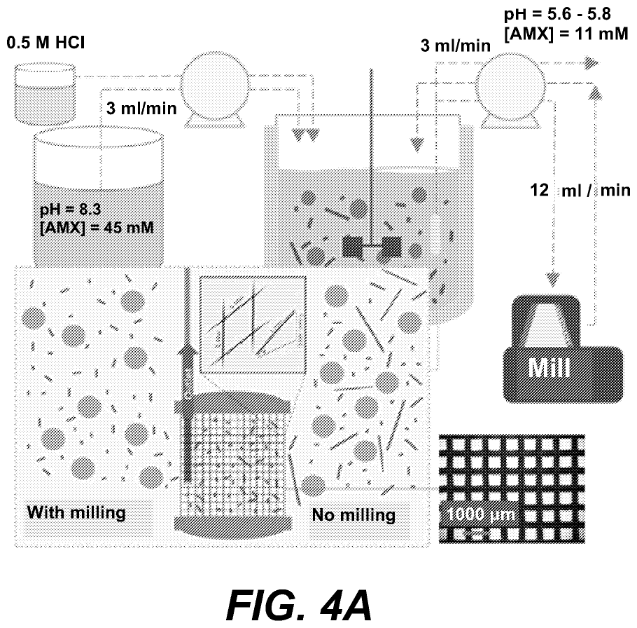

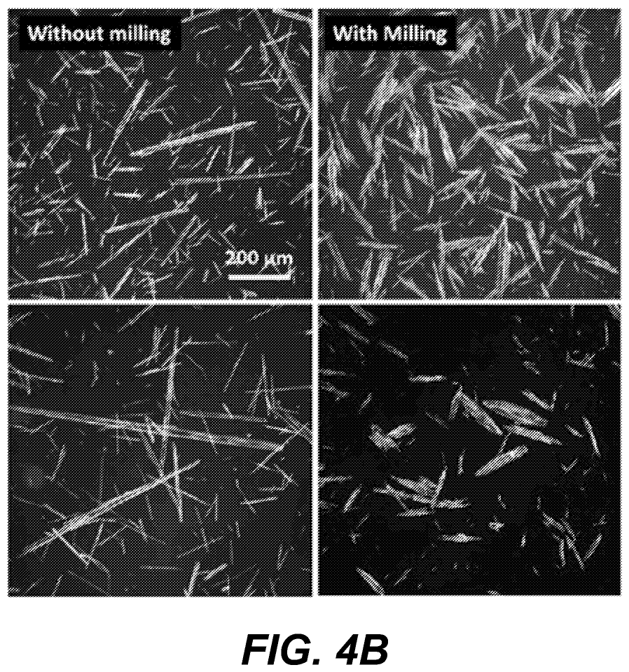

To avoid issues such as those discussed, the filter can be moved to the RC vessel to perform the separation. FIG. 4A provides a schematic representation of the disclosed separation strategy. Such a separation method can offer several advantages, including the possibility of a truly continuous process, no need for scrubbing the beads off a sieve and possible damages, flexibility in the separator design from choosing the filter geometry to filter size, and a large and three-dimensional filter area that minimizes the potential of clogging. However, the framing of L_{crystal}<L_{filter}<L_{carrier} can lead to two issues. First, the size of the carrier might impact the activity of the immobilized biocatalyst (e.g., effectiveness factor) through introducing mass transport limitations. Second, the morphology of the growing crystals might produce long needle-like particles, with a length greater than the carrier size, opposing the set separation criterion. For example, this can be seen in some processes for the production of amoxicillin trihydrate crystals that typically grow as long, 1D needle-like particles. FIG. 4B shows optical images of an AMX slurry produced in a continuous crystallization process. As can be seen, some particles can grow to be as long as 800 μm, making it challenging to choose an immobilization carrier that satisfies L_{crystal}<L_{carrier} without any hinderance to the biocatalyst effectiveness.

As disclosed herein, the applicability of the proposed solid-solid separation method to the continuous enzymatic RC of beta-lactam antibiotics with immobilized biocatalyst can be assessed by way of illustration. First, the feasible range of the separation criterion L_{crystal}<L_{filter}<L_{carrier} can be examined by determining the impact of carrier size on the biocatalyst activity and studying the applicability of intermittent wet milling of the slurry for reducing the crystal size, which can provide more flexibility in choosing the carrier size while satisfying the criterion. Finally, the effect of the proposed separation strategy on slurry withdrawal can be studied to find the conditions (L_{filter} and pumping speed) for a consistent isokinetic withdrawal where dilution and sieving effects can be minimized during the slurry transfer from the MSMPR vessel.

Lifetech ECR8404M and ECR8404F enzyme carriers can be donated by Purolite Life Sciences (King of Prussia, PA). 50% glutaraldehyde can be purchased from Amresco (Solon, OH). Cephalexin monohydrate and amoxicillin trihydrate can be purchased from RIA, Hanover, NJ. 4-hydroxy-D-phenylglycine methyl ester hydrochloride (4-HPGME HCl) >95% can be purchased from Thermo Fisher Scientific (Haverhill, MA). D-phenylglycine methyl ester hydrochloride (PGME) >95% can be purchased from Sigma (St. Louis, MO). 7-Aminodesacetoxycephalosporanic acid (7-ADCA) >98% and 6-aminopenicillanic acid (6-APA) >98% can be purchased from TCI America (Portland, OR).

The βF24A variant of PGA from E. coli can be expressed using E. coli BL21 (DE3) and purified via nickel affinity chromatography. Immobilization support sizes ranging from 300 to 800 μm can be obtained by processing Lifetech ECR8404M using sieves of sizes 300 μm, 425 μm, 600 μm, and 800 μm. Support sizes 150-300 μm can be obtained using raw samples of Lifetech ECR8404F. Carriers can be activated for immobilization by first washing a resin four times with 50 mM sodium phosphate pH 7.0 with a ratio of 1:2 (support mass/buffer volume). Resins can then be gently mixed in a solution of 1% (v/v) glutaraldehyde in 50 mmol/L sodium phosphate pH 7.0 for 1 h at room temperature. Resin can then be washed four times with 50 mM sodium phosphate buffer pH 7.0 with a ratio of 1:4 (support mass/buffer volume). 400 mg of each size range of immobilization resin can then be gently mixed with 2.3 mL of 5.5 mg/ml (Bradford assay) PGA-13F24A in 50 mM sodium phosphate at 4° C. After 16 h, the concentration of remaining enzyme in the supernatant can be measured via Bradford assay and can be below the detection limit of the assay (0.05 mg/ml) for all samples.

Immobilized enzyme (at different size ranges) can be reacted with concentrations of 6-APA ranging from 50-150 mM and 100 mM 4-HPGME for amoxicillin synthesis and concentrations of 7-ADCA ranging from 50-150 mM and 100 mM PGME for cephalexin synthesis. Reactions can be buffered with 50 mM sodium phosphate pH 6.5 and can be limited to <10% conversion to ensure initial rate reaction conditions. Briefly, 10 mL of reaction solution incubated in a 25° C. water bath for >10 min can be added to 400 mg of enzyme supports in 20 ml gravity columns. The reaction can be mixed by inverting the sealed gravity column. 50 μL of reaction solution can be withdrawn at time points ranging 1-15 min and diluted in methanol for high-performance liquid chromatography (HPLC, Shimadzu) analysis with a 4.6×250 mm HiChrom Ultrasphere ODS column. The amoxicillin and cephalexin synthesis activity can be determined from the slope of the concentration versus time curve for amoxicillin and cephalexin. The selectivity of the reaction can be determined by taking the ratio of amoxicillin to 4-HPG accumulation or the ratio of cephalexin to PG accumulation in the cases of amoxicillin or cephalexin synthesis, respectively.

Continuous crystallization experiments can be conducted to produce an AMX slurry which can then be used to test withdrawal with different filter sizes and pumping speeds. Considering that AMX solubility in water is a function of pH, instead of using the PGA enzyme for these tests, supersaturation can be induced by controlling the crystallizer pH value (in the actual enzymatic RC AMX synthesis generates supersaturation). Accordingly, a 45 mM solution of AMX (AMX stocks can first be purified by batch crystallization) at pH=8.3 (high solubility, ˜45 mM) can be prepared and can be placed in a 2 L feed tank cooled to 7° C. to minimize degradation over the course of the continuous crystallization experiment. Reactor pH can be controlled at 5.6-5.8 (low solubility, ˜7 mM) using a Mettler Toledo SP-50 dosing unit by adding 0.5 M HCl. The crystallizer can be a jacketed vessel that was maintained at 25.0° C. and was mixed at 250 RPM using a pitched-blade stainless-steel impeller with ˜1.5-cm off- bottom clearance. Inlet and outlet flowrates can be controlled using Ismatech peristaltic pumps (REGLO-ICC 3 channels). The reactor volume can be set to 240 mL and the inlet and outlet flowrates to a net 3 mL/min providing a residence time of 80 min (outlet flowrate at 10 mL/min but intermittent). The residence time can be chosen so that the reactor solids density can be close to that of the design point for the continuous enzymatic RC. An 80-min residence time can correspond to a solids density of about 14 g/L of slurry at steady state for the case with intermittent milling.

FIG. 4A shows the overall process and the parameters used for continuous crystallization experiments. Two sets of experiments can be performed with and without wet milling of the slurry. Intermittent wet milling can be implemented by recirculating the slurry through an IKA Inc. Magic Lab mill with an MK module (with a constant 12 mL/min flowrate in/out of the mill). Different milling intensities (3000-8000 RPM) and frequencies can be tested. 5000 RPM and a milling rate of 15-min-ON 7-min-OFF can be selected for final tests. Each continuous crystallization can be operated for at least four residence times to ensure reaching the steady state, which can be confirmed by a relatively constant crystal count, turbidity, and outlet concentration as measured by a ParticleTrack G400 FBRM probe, an Easy Viewer 100 PVM probe, and HPLC, respectively. The slurry at steady state can then be used for performing the slurry withdrawal tests with the separator filter. The filter can be offline prior to these tests to omit its potential impact on arriving at steady state.

Slurry withdrawal tests can be performed on both milled and un-milled slurries using separator filters with sizes ranging from 149-800 μm. Filters (with a diameter of approximately 0.5 in. and height of 4 in.) can be made using stainless steel mesh screens with a straight weave (Utah Biodiesel). The filter and connected outlet tubing can be located close to the vessel wall and at a depth of about 50% of the liquid level.35 For each filter, a series of withdrawal speeds ranging from 3 to 20 mL/min can be tested to study the impact of filter size and withdrawal speed on representative slurry withdrawal. Properties (crystal solids density and crystal mean size) of the samples withdrawn can then be compared against those of the reactor slurry to identify the withdrawal method closest to isokinetic. For each sample, solids density can be estimated by drying the withdrawn sample at 70° C. and then subtracting the solid mass generated due to evaporative crystallization (measured by weighing control samples containing only the liquid phase) from the total mass to find the mass of primary crystals. Measurements can be performed in triplicate for each withdrawal condition. Crystal mean size can be estimated by optical microscopy and image analysis to estimate the length of the labeled crystals.

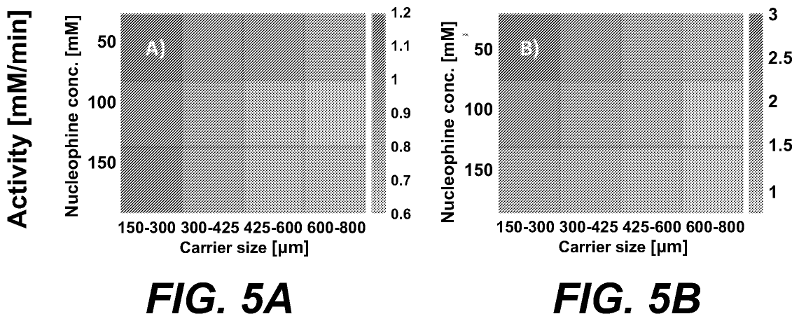

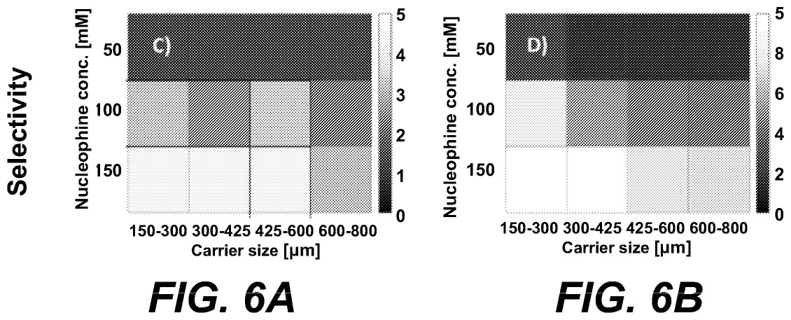

FIGS. 5A and 5B along with FIGS. 6A and 6B show the impact of the size of beads carrying the PGA enzyme and the concentration of the beta-lactam nucleophile (6-APA or 7-ADCA) on the selectivity and activity of amoxicillin and cephalexin synthesis. Focusing on amoxicillin synthesis, FIGS. 5A-6B indicate that the catalyst activity can decrease with increasing bead size for all concentrations of 6-APA investigated. The effect of size can be slightly more prominent at lower 6-APA concentrations where the enzyme is more active due to less substrate inhibition. On the other hand, the selectivity of amoxicillin synthesis is not a strong function of carrier size, as indicated by no clear trends along the horizontal axis. Shifting focus to cephalexin, the activity of cephalexin synthesis can exhibit a strong function of carrier size, decreasing by roughly 50% from the smallest carrier tested to the largest carrier for the 50 mM 7-ADCA reactions. Likewise, the selectivity of cephalexin synthesis can decrease with increasing carrier size for all 7-ADCA concentrations. The activity of PGA can be more sensitive to carrier size for cephalexin synthesis, possibly due to the intrinsically higher reaction rate for cephalexin synthesis using the soluble enzyme. Overall, the experimental results reiterate the fact that enzyme carrier size can have a significant impact on its apparent kinetics and performance. Therefore, one cannot freely increase L_{carrier} to satisfy the separation criterion L_{crystal}<L_{filter}<L_{carrier}. Further below, it can be seen that intermittent wet milling can help to relax the condition by reducing the L_{crystal}, allowing the use of smaller L_{carrier} values.

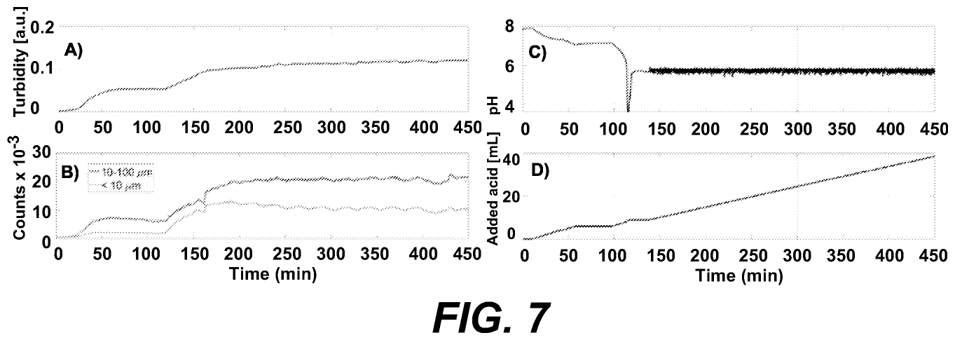

FIG. 7 shows an example of the evolution of conditions in the continuous crystallization process from startup to steady state (as mentioned, in these runs pH can be used to drive the crystallization). All solid-phase data (crystal counts and solution turbidity) can indicate a relatively constant behavior after about 6 hours of operation (almost 5 residence times). The fixed slope of the added acid line and HPLC data (not shown) can also confirm the approach to steady-state operation. FIG. 7 also shows an in-situ image of long crystals grown during the initial batch-mode operation when no milling is yet performed, as well as the slurry at around 360 min when intermittent milling can lead to a slurry with significantly smaller crystals. The slurry at steady state can be used to perform a series of slurry transfer tests with the separator filters. The steady-state solids density for the case in which intermittent milling was implemented during the continuous crystallization can be higher compared to the one with no milling (˜14 versus ˜11 mg/mL), which can indicate an increased rate of crystallization due to more available growth surface area.

One concern for the disclosed solid-solid separation method can be the potential interference of the separator filter with slurry withdrawal. For a robust continuous RC process, an isokinetic slurry withdrawal can be desirable. Note that if crystals with L_{crystal}>L_{filter} are produced and cannot leave the system through the outlet, large crystals can accumulate in the system, eventually halting the operation. The slurry withdrawn from the MSMPR can have a lower solids density than the reactor, which can result from selective removal of smaller crystals or other factors related to the resistances imposed by the filter. To study the impact of the separator filter on the slurry transfer, withdrawal of the steady-state slurry can be performed by using different filters and at different withdrawal rates for systems with and without intermittent milling.

Before analyzing the impact of filter size on slurry withdrawal, it is notable that the likelihood of a crystal passing the filter can drop sharply as the particle size (as defined by a characteristic dimension, its length for example) becomes greater than the filter size. However, due to the needle-like shape of AMX crystals, even those larger than the filter size can have a non-zero probability of passing through the filter, providing some flexibility in choosing the acceptable filter size (rather than the hard limit of L_{crystal}, max<L_{filter}). Note that this may not be the case for the spherical biocatalyst carrier, and that the L_{filter}<L_{carrier} condition can facilitate that the biocatalyst carrier cannot leave the system through the outlet.

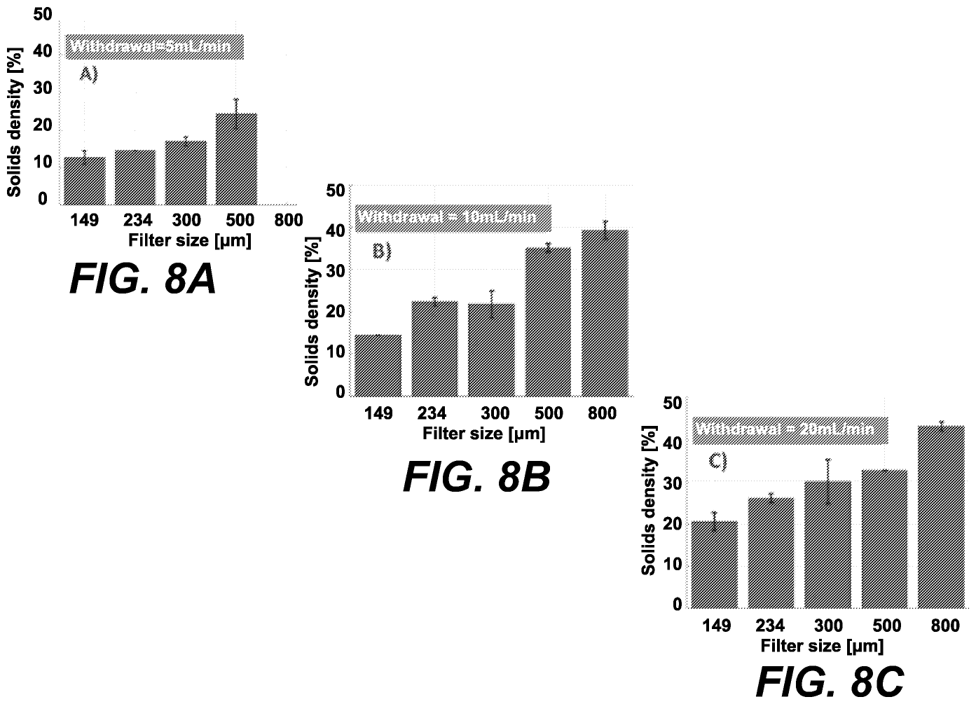

FIGS. 8A-C compare solids densities of the withdrawn slurry using different filters at different withdrawal rates against that of the MSMPR. For example, FIGS. 8A-C show that at a slurry withdrawal rate of 5 mL/min, solids density can increase with increasing the filter mesh size. Values can be normalized with respect to the reactor solids density at steady state. FIGS. 8A-C show that there can be a significant dilution effect in the slurry transfer due to the presence of the separator filter. Even for the coarsest filter, 800 μm, and at the highest withdrawal rate, the solids density can still be about 55% less in the withdrawn slurry. Without wishing to be bound by any particular scientific theory, this loss can become larger as the filter size or withdrawal rate is reduced.

Another observation is that even when no filter is placed on the outlet, it can still be challenging to withdraw a representative sample, and large-diameter tubing can be used; this can be mainly due to occasional clogging initiated by some very long crystals. Tubing diameter five to ten times the size of the largest crystals can be desirable to avoid this issue. Intermittent pressure-driven withdrawal at high speeds can usually be used for isokinetic withdrawal in continuous crystallization processes. However, as will be shown, analysis of the crystal size can confirm that the main reason behind significant dilution during slurry withdrawal, without wishing to be bound by any particular scientific theory, can be the inability of larger crystals to pass the separator filter.

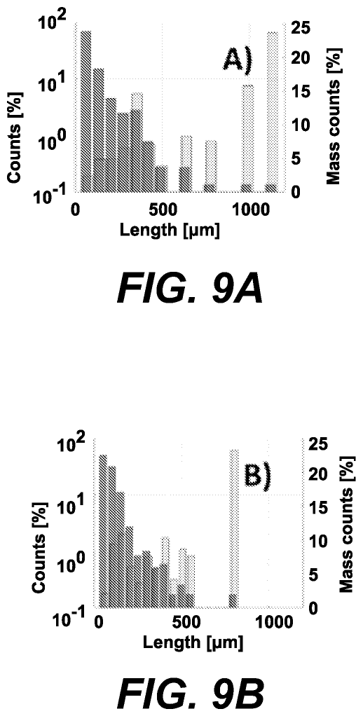

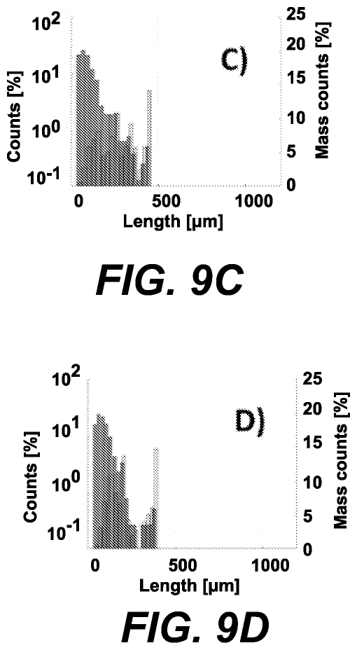

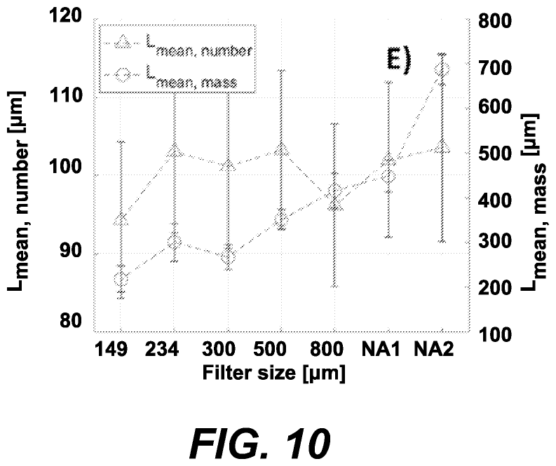

The potential of selective removal of crystals due to the separator filter or withdrawal rate can be examined by observing the crystal size distribution (CSD) of crystals in the slurry withdrawn using different filter sizes and withdrawal rates. For each sample, CSD can be determined using optical microscopy and image analysis to assign a length to each of the detected objects (objects smaller than 25 μm can be excluded from the analysis as they are very likely to be unaffected by the filter). FIGS. 9A-D show the CSD and the mean size of the samples withdrawn with different filters. For all cases, a withdrawal rate of 20 mL/min can be used. As can be seen, there can be some probability for particles with L_{crystal}>L_{filter} to pass the filter in the case of needle-like crystals. However, without wishing to be bound by any particular scientific theory, a significant correlation can be seen between the size of the filter used and the CSD in the slurry withdrawn. Crystals significantly larger than the filter cannot pass the filter and so are missing from the CSD. This can be seen more clearly in the mass-based distribution. As shown in FIG. 10, the number-based mean size is almost similar for all samples due to the fact that the CSD is dominated by smaller crystals, while mass-based mean size points to a strong correlation with the filter size used for withdrawal. As shown, the dilution effect discussed above can mostly be due to selective removal of smaller crystals in the slurry. Note that the presence of very large crystals in the original MSMPR slurry can be partially due to some non-idealities in the withdrawal during the continuous crystallization process; nevertheless, analysis of FIGS. 8-10 can confirm that the filter prevents a robust slurry transfer of AMX slurry made without milling mainly by not allowing the larger crystals to leave the system.

The results described above can demonstrate the necessity of reducing crystal size in order to match the size (and activity and selectivity) of a biocatalyst carrier bead; otherwise, the separation criterion cannot be satisfied. Furthermore, without reducing crystal size, the separator filter may not allow isokinetic withdrawal. Considering the analysis of biocatalyst activity and selectivity, for the disclosed examples, a carrier bead with L_{carrier}<425 μm can be desirable. Therefore, the maximum crystal size can be within this limit to satisfy the separation condition L_{crystal}<L_{carrier} (with some flexibility due to the 1D nature of crystals discussed above). Milling can provide an appropriate reduction in crystal size and the specific milling parameters disclosed herein can be selected to achieve this goal. Similar to the above disclosure, continuous crystallization with intermittent milling can be operated for at least four residence times until concentration measurements and PAT signals confirmed steady-state operation.

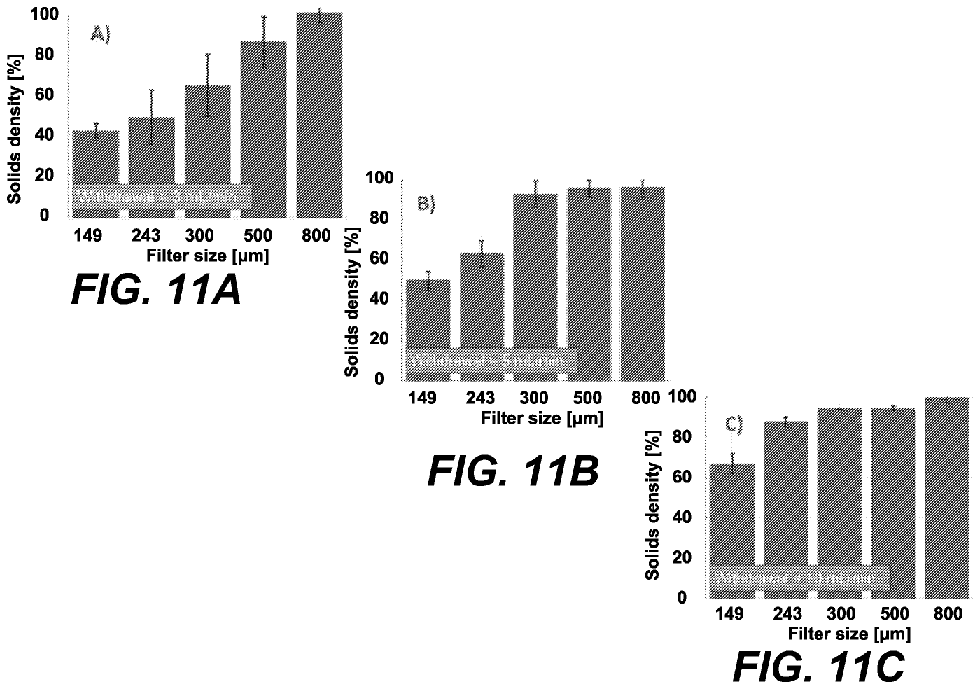

FIGS. 11A-C show the solids density of the slurry samples withdrawn using different filter sizes. Outlet pump speed can be varied from 3 to 10 mL/min. Intermittent milling can facilitate withdrawal when compared to the results without milling; several combinations of withdrawal speed and filter size can match the solids density produced in the MSMPR. However, as pumping speed and filter size decrease, a dilution effect can be introduced into the withdrawal process. This can be significant for L_{filter}<300 μm, and pumping speed below 5 mL/min. As expected, the worst case can correspond to using the finest filter (149 μm) and the lowest speed (3 mL/min) in which case the outlet can withdraw only about 40% of the MSMPR solids content. As shown, using the pump speed of 5-10 mL/min and a filter size larger than 300 μm can ensure that the withdrawn sample has the same solids density as the crystallization vessel, meaning as long as the diameter of the biocatalyst support is larger than 300 μm, solid-solid separation and robust slurry transfer can be continuously performed using the proposed method. Therefore, 300 μm<L_{carrier}<425 μm can correspond to one example of a workable bead size range for the disclosed processes.

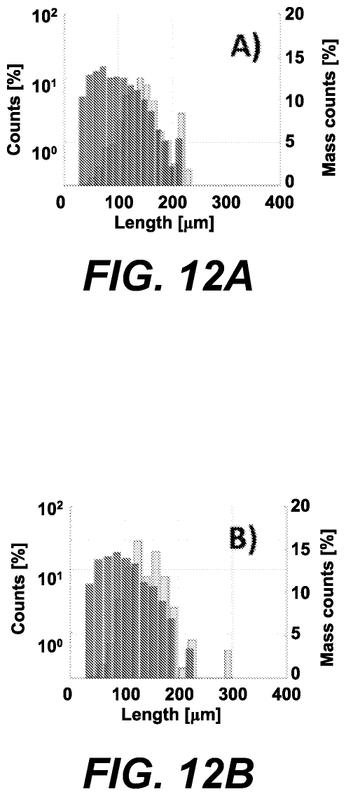

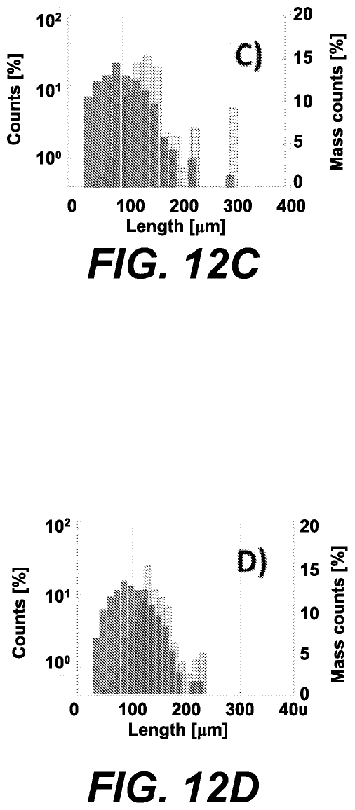

The crystal size distribution of samples withdrawn through different filters can be studied to investigate the possibility of selective crystal withdrawal from the crystallizer. FIGS. 12A-D compare the CSD, along with the number-based and mass-based mean lengths for different filter sizes. For all cases, a pumping speed of 10 mL/min can be used. Statistical tests such as one-way ANOVA can be used to check whether different groups (filters) have a common mean size and if the difference between mean sizes is significant. For example, comparing the CSD of the sample withdrawn with 234 μm filter against that of the MSMPR can result in a p-value of 0.7, confirming that the difference in the mean size is not significant. However, note that even if the filter results in the preferential withdrawal of smaller crystals to a slight degree, or if there is a small difference between mean size of different samples, milling can prevent the formation and accumulation of enlarged stable particles in the reactor.

As seen in FIGS. 11A-C, using the filter size of 149 μm can result in some loss in the solids density in the slurry but does not seem to pose a significant sieving effect (preferential removal of small crystals). Without wishing to be bound by any particular scientific theory, this can indicate that another reason for the loss in solids density for the 149 μm filter can be the resistance of the filter against the flow, which can strongly affect the flow field and cause weak mixing for the part of the slurry that is inside the filter (while the reactor slurry is still well-mixed). In fact, operating the continuous process for several hours, some settled crystals can be visibly seen at the bottom of this filter, confirming that the weak mixing inside the filter can be the main reason for the above loss. While this effect was not significant for coarser filters, solutions such as a more intense mixing, placing a bubbler at the bottom of the filter, or periodic filter exchange can ensure good mixing and avoid any crystal settling inside the filter for long-term continuous operation.

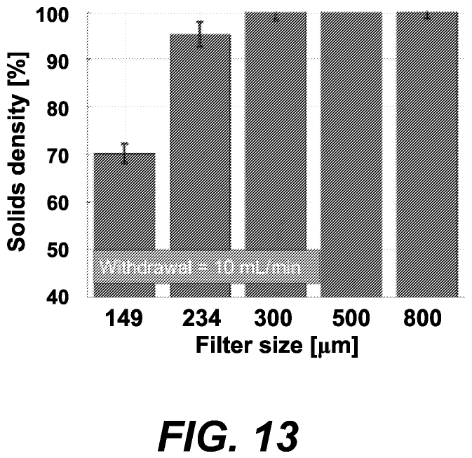

Another factor that can impact the withdrawal efficiency when the separator filter is used is the MSMPR solids density at the steady state. To investigate whether the proposed withdrawal strategy can also be applicable to cases with a higher solids density, similar tests can be performed using a crystal slurry with a significantly higher solid content (21.1 mg/mL compared to 13.8 mg/mL of FIGS. 11A-C). As shown in FIG. 13, even for the slurry with a significantly higher solid content, representative slurry withdrawal can be achieved using filters with L_{filter}>300 μm when intermittent milling is applied to keep the size of the crystals in an acceptable range.

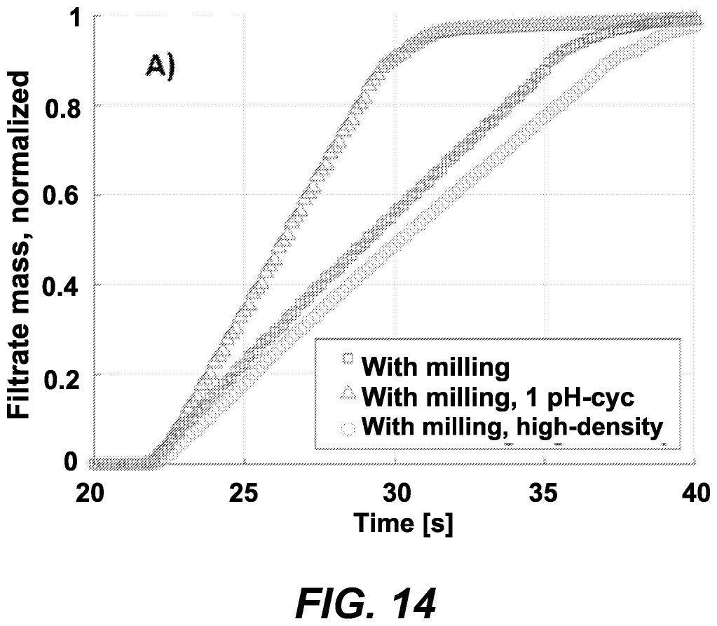

One possible downside of using intermittent milling to reduce the size of the crystals, and thereby facilitate their separation from the biocatalyst carrier, can be generation of significant crystal fines. These small particles easily pass through the filter but might complicate downstream processing, for example by increasing the filtration times. FIG. 14 compares the filtration rate of the AMX slurries produced with and without intermittent milling. The presence of fines induced by milling can result in slightly slower filtration. This side effect can be one factor preventing the use of very intense milling to reduce the crystal size for better solid-solid separation. Other factors limiting milling can include formation of local thermal hotspots that might cause degradation of the AMX (or CEX) molecules and foam generation. A potential solution to the slower filtration problem can be to remove fines by implementing a pH cycle in a secondary vessel in which the pH value of the slurry with fines is increased (to dissolve the fines) and then decreased to the initial value. A similar approach can be used in other systems for fines removal using temperature cycling. As can be seen in FIG. 14, implementing only one pH cycle (from 5.8 to 7.9 to 5.8) results in a visible improvement in the filtration rate.

Another observation during the continuous crystallization experiments with intermittent milling can be a slight change in the crystal growth habit of AMX crystals. Crystals from the system with milling can have a lower aspect ratio and show a slightly greater growth along directions other than their major axis. This can be due to the fact that milling can be much more likely to break the crystals along their major axis and while the intrinsic growth rates for different planes remain constant, this can result in particles with lower aspect ratios.

Disclosed herein is a simple size-based method for the solid-solid separation of crystals from biocatalyst carrier particles to enable the continuous operation of enzymatic reactive crystallization processes. The method can utilize a mesh filter through which product slurry can be withdrawn. The primary considerations for choosing the appropriate filter characteristics can be the size of the biocatalyst carrier beads and the size of the product crystals. Enzymatic assays can be performed to evaluate the impact of carrier size on the performance of the immobilized PGA, confirming an increasing loss in both enzyme activity and selectivity with larger bead sizes. Intermittent wet milling can be an effective tool in manipulating the size of product crystals so that they could be removed appropriately (without classification and slurry dilution). The selected relationship between bead size and milling can allow the use of relatively smaller carrier beads, and hence more active and selective immobilized biocatalyst, while still satisfying the criterion for the solid-solid separation L_{crystal}<L_{filter}<L_{carrier}. Using the carrier size range of 300-425 μm and filter size of 300 μm in combination with intermittent milling at 5000 RPM and a high withdrawal speed can be shown to guarantee an almost complete separation while enabling isokinetic product withdrawal.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

1. A continuous reaction system comprising:
a reaction vessel comprising:
an inlet line to provide a reactant to an interior volume of the reaction vessel such that the reactant contacts at least a portion of inert scaffold particles contained in interior volume;
an outlet line to remove a product from the interior volume that results from a contact between the reactant and the inert scaffold particles, the product being in a solid state; and
a sieve material disposed on the outlet line within the interior volume, the sieve material configured to reject the inert scaffold particles and allow the product to pass therethrough into the outlet line.

2. The continuous reaction system of claim 1, further comprising:
a comminution unit having an inlet line connected to the reaction vessel; and
a recycle line connected with the interior volume of the reaction vessel;
wherein the comminution unit is configured to reduce a particle size of the product in the solid state subsequent to the product passing through the sieve material.

3. The continuous reaction system of claim 2, wherein at least one of:
the sieve material has a pore size, and the size of the inert scaffold particles is greater than the pore size;
the sieve material achieves isokinetic withdrawal of the product in the solid state; or
the inert scaffold particles contain an active catalyst.

4. (canceled)

5. The continuous reaction system of claim 2, wherein the contact between the reactant and the inert scaffold particles causes a reaction facilitated by an active catalyst of the inert scaffold particles.

6. The continuous reaction system of claim 5, wherein the reaction occurs within the interior volume; and
wherein the product is formed prior to contact with the sieve material.

7. The continuous reaction system of claim 5, wherein the reaction is a crystallization reaction to create the product in the solid state; and
wherein the solid state is a crystalline state.

8. A continuous reaction system comprising:
a reaction vessel comprising:
an inlet line to provide one or more reactants to an interior volume of the reaction vessel such that the one or more reactants contact at least a portion of inert scaffold particles contained in interior volume;
an outlet line to remove one or more products from the interior volume that result from a contact between the one or more reactants and the inert scaffold particles, the one or more products being in a solid state; and
a sieve material disposed on the outlet line within the interior volume, the sieve material configured to reject the inert scaffold particles and allow the one or more products to pass therethrough into the outlet line;
a comminution unit having an inlet line connected to the reaction vessel; and
a recycle line connected with the interior volume of the reaction vessel;
wherein the comminution unit is configured to reduce a particle size of the one or more products in the solid state subsequent to the one or more products passing through the sieve material.

9. The continuous reaction system of claim 8, further comprising:
a separation unit having:
an inlet line connected with the outlet line of the reaction vessel;
a retentate line connected with the inlet line of the comminution unit; and
a permeate line;
wherein the separation unit is configured to:
allow the one or more products having a size below a predetermined threshold to pass through into the permeate line; and
reject the one or more products having a size above the predetermined threshold to flow into the retentate line and to the inlet line of the comminution unit.

10. The continuous reaction system of claim 8, wherein the comminution unit is a mill.

11. The continuous reaction system of claim 8, wherein the comminution unit is further configured to reduce the particle size of the one or more products to achieve a predetermined particle size distribution.

12. The continuous reaction system of claim 11, wherein the particle size distribution is selected to achieve isokinetic withdrawal of the one or more products in the solid state from the reaction vessel.

13. A continuous reaction method comprising:
feeding, to an interior volume of a reaction vessel, one or more reactants;
contacting the one or more reactants with a plurality of inert scaffold particles within the interior volume to form one or more products, the plurality of inert scaffold particles and the one or more products being in a solid state;
sieving the one or more products through a sieve material configured to reject the plurality of inert scaffold particles and allow the one or more products in the solid state to pass therethrough and exit the reaction vessel;
reducing, by a comminution unit, a particle size of the sieved one or more products in the solid state; and
feeding, to the interior volume, the one or more products of reduced particle size from the comminution unit.

14. The continuous reaction method of claim 13, wherein at least one of:
the sieve material has a pore size, and the size of each of the plurality of inert scaffold particles is greater than the pore size;
sieving the one or more products through the sieve material is performed to achieve isokinetic withdrawal of the one or more products in the solid state; or
each of the plurality of inert scaffold particles contains an active catalyst.

15.-16. (canceled)

17. The continuous reaction method of claim 13, wherein each of the plurality of inert scaffold particles contains an active catalyst; and
wherein contacting the one or more reactants with the plurality of inert scaffold particles comprises a reaction facilitated by the active catalyst.

18. The continuous reaction method of claim 17, wherein the reaction occurs within the interior volume and the one or more products are formed prior to contact with the sieve material.

19. The continuous reaction method of claim 17, wherein the reaction is a crystallization reaction to create the one or more products in the solid state; and
wherein the solid state is a crystalline state.

20. (canceled)

21. The continuous reaction method of claim 13 further comprising:
permeating, by a separation unit, the sieved one or more products exiting the reaction vessel having a size below a predetermined threshold into a permeate line; and
rejecting, by the separation unit, the sieved one or more products having a size above the predetermined threshold into the comminution unit;
wherein the reducing comprises reducing the particle size of the sieved and rejected one or more products in the solid state.

22. The continuous reaction method of claim 13, wherein the comminution unit is a mill.

23. The continuous reaction method of claim 13, wherein the reducing the particle size of the sieved one or more products achieves a predetermined particle size distribution.

24. The continuous reaction method of claim 23, wherein the particle size distribution is selected to achieve isokinetic withdrawal of the one or more products in the solid state from the reaction vessel.
